(19) United States
(12) Patent Application Publication
(10) Pub. No.: US 2016/0078801 A1
(43) Pub. Date: Mar. 17, 2016

(54) DISPLAY APPARATUS AND BACKLIGHT DRIVING METHOD OF THE SAME

(71) Applicant: Innolux Corporation, Miao-Li County (TW)

(72) Inventors: Ming-Feng Hsieh, Miao-Li County (TW); Tzu-Chien Chuang, Miao-Li County (TW); Tsung-Fu Huang, Miao-Li County (TW)

(21) Appl. No.: 14/824,172

(22) Filed: Aug. 12, 2015

(30) Foreign Application Priority Data
Sep. 12, 2014 (TW) 103131519

(51) Int. Cl. G09G 3/32

(52) U.S. Cl. CPC G09G 3/32; G09G 2310/0237

(57) ABSTRACT

A display apparatus and a backlight driving method of the same are provided. The display apparatus includes a backlight module and a display panel. The backlight module includes at least one LED unit having a red phosphor. The backlight module turns on the LED unit at least twice within a frame period, and maintains the ON-state of the LED unit for a first ON-state interval and a second ON-state interval. The second ON-state interval is shorter than the first ON-state interval. The display panel is disposed corresponding to the backlight module.

This application claims the benefit of Taiwan application Serial No. 103131519, filed Sep. 12, 2014, the subject matter of which is incorporated herein by reference.

### BACKGROUND OF THE INVENTION

1. Field of the Invention

The invention relates in general to a display apparatus and more particularly to a display apparatus having a light-emitting diode (LED) backlight source and a backlight driving method of the same.

2. Description of the Related Art

Having the features of long lifespan, small volume, low heat output and low energy loss, light emitting diode (LED) assembled with LCD (liquid crystal display) has gradually replaced conventional cathode ray tube (CRT) display and become a mainstream product in the display market.

In recent years, the development of display is mainly directed towards multi-color and high brightness. In order to achieve a full-color display frame, normally the LED chips of RGB visible lights are assembled together in a backlight module, such that the visible lights having various wavelengths can be mixed to form a white light source. This design requires a larger number of LED package structures, and will incur more cost and a bigger assembled structure.

Currently, an LED unit composed of blue LED chips doped with a red phosphor is already provided to replace conventional LED unit composed of multi-chips. Since the LED unit comprises blue LED chips doped with a red phosphor has higher luminous efficiency and one single LED package structure would provide a white light source, the number of LED package structures and the configuration volume can both be reduced.

Although the LED unit having a red phosphor can increase color saturation, the response rate is lower, and red blurring may occur to dynamic images of the liquid crystal display (LCD). Particularly, when local dimming technology is used to adjust the brightness of visible region to highlight the contrast ratio of frame, color saturation of images normally will have significant change. When backlight scanning technology is used to reduce dynamic image sticking, red blurring will affect the clarity of dynamic images and deteriorate the display quality.

Therefore, it has become a prominent task for the industries to provide an advanced LED backlight module and its application to resolve the problems in the generally known technology.

### SUMMARY OF THE INVENTION

According to a first aspect of the present embodiment, a display apparatus is provided. The display apparatus includes a backlight module and a display panel. The backlight module includes at least one LED unit having a red phosphor. The backlight module turns on the LED unit at least twice within a frame period, and maintains the ON-state of the LED unit for a first ON-state interval and a second ON-state interval. The second ON-state interval is shorter than the first ON-state interval. The display panel is disposed corresponding to the backlight module.

According to a second aspect of the present embodiment, a backlight driving method of a display apparatus is provided. The driving method is used for a backlight module having at least one LED unit. The method includes following steps: Firstly, a duty ratio and a brightness of the LED unit is calculated according to an image data within a frame period. Then, a current is provided according to the duty ratio and the brightness to turn on/off the LED unit at least twice within the frame period and maintain the ON-state of the LED unit for at least a first ON-state interval and a second ON-state interval, wherein the second ON-state interval is shorter than the first ON-state interval.

According to the above disclosure, a display apparatus and a backlight driving method of the same are provided in embodiments of the invention. The display apparatus includes a backlight module used for driving a backlight driving module of the backlight module and a display panel used for receiving a light emitted from the backlight module. The backlight module has at least one LED unit. The backlight driving module of the backlight module modulates the current to turn on the LED unit within a frame period and maintain the ON-state of the LED unit for a longer ON-state interval, such that local dimming can be performed on the display apparatus to moderate the red blurring problem due to the long response time of the red phosphor of the LED unit. Following the primary ON-state interval, the LED unit is briefly turned on again at least once, and the backlight scanning technology is used to further eliminate the phenomenon of red blurring and dynamic image sticking, such that the clarity of dynamic images and the display quality can further be improved.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a system block diagram of a display apparatus according to an embodiment of the invention;

FIG. 2 is a partial cross-sectional diagram of the structure of a backlight module according to an embodiment of the invention;

FIG. 3 is a spectrum of various white LED units according to an embodiment of the invention;

FIG. 4 is a flowchart of a backlight driving method according to an embodiment of the invention;

FIG. 5 is a timing diagram of local dimming performed by the LED unit driven by the driving method of FIG. 4 according to an embodiment of the invention;

FIG. 6 is a timing diagram of local dimming performed by the LED unit driven by the driving method of FIG. 4 according to another embodiment of the invention;

FIG. 7 is a timing diagram of local dimming performed by the LED unit driven by the method of FIG. 6 according to another embodiment of the invention, wherein the duty ratio of the ON-state is substantially 80%; and

FIG. 8 is a timing diagram of local dimming performed by the LED unit driven by the driving method of FIG. 4 according to an alternate embodiment of the invention.

### DETAILED DESCRIPTION OF THE INVENTION

One of the embodiment of the present invention provides a display apparatus and a backlight driving method of the same for resolving the problem of red blurring caused by the LED unit when the response time is too long and eliminating dynamic image sticking to improve the clarity of dynamic images and the display quality. The above and other objects, features and advantages of the present invention will become better understood with regard to a number of exemplary embodiments disclosed below with accompanying drawings.

It is to be understood that the specific implementations and methods disclosed below are not for limiting the invention, which can also be implemented by using other features, components, methods and parameters. The exemplary embodiments disclosed below are for exemplifying the technical features of the invention only, not for limiting the scope of protection of the invention. Anyone who is skilled in the technology field of the technology will be able to make equivalent modification and variations according to the descriptions of the specification without violating the spirit of the invention. For components common to different embodiments and drawings, the same numeric designations are used.

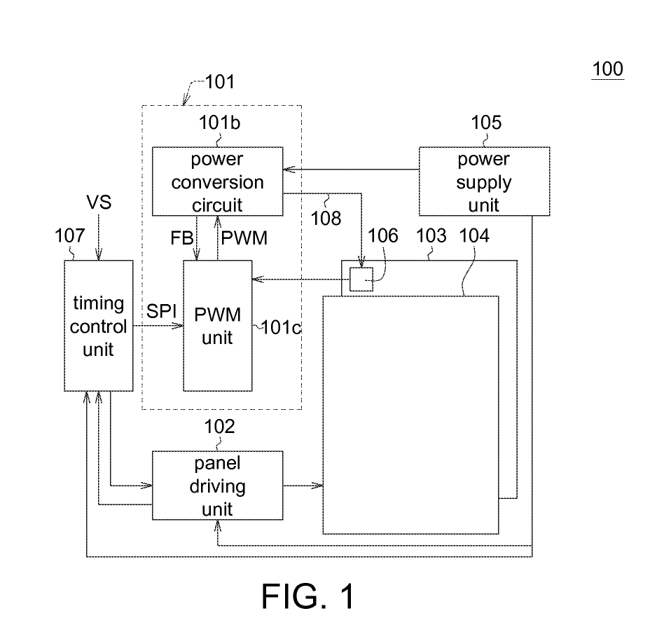

FIG. 1 is a system block diagram of a display apparatus 100 according to an embodiment of the invention. As indicated in FIG. 1, the display apparatus 100 includes a timing control unit 107, a backlight driving module 101, a panel driving unit 102, a backlight module 103, a display panel 104 and a power supply unit 105. The backlight driving module 101 includes a power conversion circuit 101b and a pulse width modulation (PWM) unit 101c. The panel driving unit 102 is electrically connected between the timing control unit 107 and the display panel 104. The timing control unit 107 is electrically connected to the backlight module 103 via the PWM unit 101c and the power conversion circuit 101b. Each of the timing control unit 107, the panel driving unit 102 and the power conversion circuit 101b is electrically connected to the power supply unit 105.

The timing control unit 107 receives a plurality of image data VS, and performs a computing process on the image data VS to control the operation of each unit such as the panel driving unit 102 and the backlight module 103. In other words, after the timing control unit 107 received the image data VS and performed the computing process thereon, the image data VS are converted into a backlight control signal 108 by the PWM unit 101c. Then, the power conversion circuit 101b adjusts the LED unit 106 of the backlight module 103 corresponding to each light emitting region (not illustrated) of the display panel 104 according to the backlight control signal 108 to control the luminous brightness of each light emitting region. The panel driving unit 102 display an image on the display panel 104 according to the image data VS outputted from the timing control unit 107 and the light source provided by the backlight module 103.

In the present embodiment, the timing control unit 107 calculates the duty ratio, ON-OFF interval and brightness of each LED unit 106 within a frame period according to the image data VS, and outputs the calculated duty ratio, ON-OFF interval and brightness to the PWM unit 101c through a serial peripheral interface (SPI). Then, the PWM unit 101c determines the pulse width of the current provided by the power conversion circuit 101b according to the calculated duty ratio, ON-OFF interval and brightness. The power conversion circuit 101b adjusts the turn-off/turn-on time and the intensity of the current of each LED unit 106 within a frame period according to the pulse width signal PWM outputted from the PWM unit 101c, and further sends a feedback signal FB which reflects the situation of implementation to the PWM unit 101c. That is, the ON-OFF interval, the turn-on time and the intensity of the current of each LED unit 106 within a frame period are controlled by way of pulse width modulation to adjust the required brightness and accordingly control the luminous brightness of each light emitting region.

In some embodiments of the invention, the display panel 104 is not self-luminous and the light source is provided by the backlight module 103. For example, the display panel 104 can be realized by such as a liquid crystal display (LCD), a liquid crystal on silicon (LCOS) display or a non-homogeneous polymer dispersed liquid crystal display (NPD-LCD).

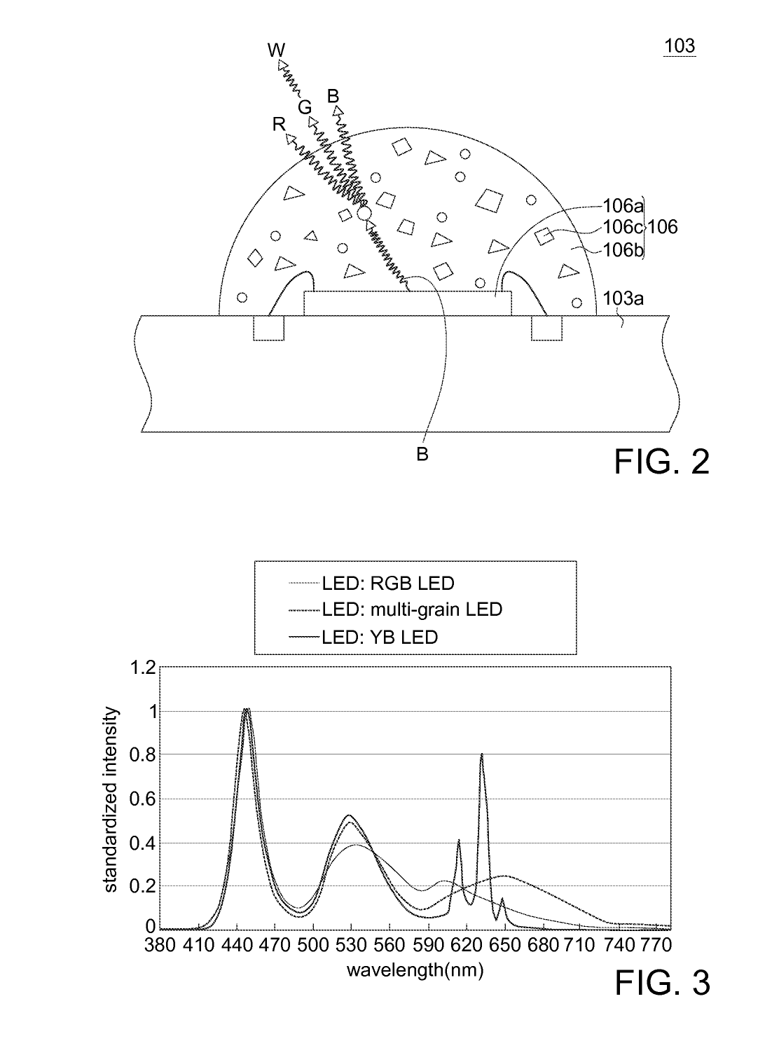

The backlight module 103 uses a plurality of LED units 106 as a light source. Referring to FIG. 2, a partial cross-sectional diagram of the structure of a backlight module 103 according to an embodiment of the invention is shown. The backlight module 103 includes at least one LED unit 106 located on the backlight substrate 103a. The LED unit 106 is composed of at least one blue LED chip 106a, an epoxy sealant 106b covering the blue LED chip 106a, and a red phosphor 106c embedded in the epoxy sealant 106b and covering the blue LED chip 106a.

In some embodiments of the invention, when the red phosphor 106c is excited by a blue light B emitted from the blue LED chip 106a, the red phosphor 106c will emit a red light R. The LED unit 106 can further be doped with a green phosphor (not illustrated) to emit a green light G. The red light R, the green G and the blue light B can be mixed to form a white light W. In some other embodiments of the invention, a yellow phosphor can be used. When the yellow phosphor is excited by the blue light B emitted from the blue LED chip 106a, the yellow phosphor will emit a yellow light (not illustrated), which can be mixed with the blue light B to form a white light W. In present embodiment, the LED unit 106 forms a white light by mixing RGB (red/green/blue) lights. Preferably, the wavelength of the red phosphor 106c is between 600˜750 nanometers (nm).

Referring to FIG. 3, a spectrum of various white LED units according to an embodiment of the invention is shown. A comparison between the spectrum of the LED unit 106 provided in an embodiment of the invention, a multi-chip LED unit and a yellow/blue (YB) LED unit shows that: the LED unit 106 provided in an embodiment of the invention has a more obvious peak when the wavelength is within the range of red visible light. This implies that the red light of the LED unit 106 has higher color purity than the multi-chip LED unit and the YB LED unit, and advantageously increases the brightness and saturation of the display 100.

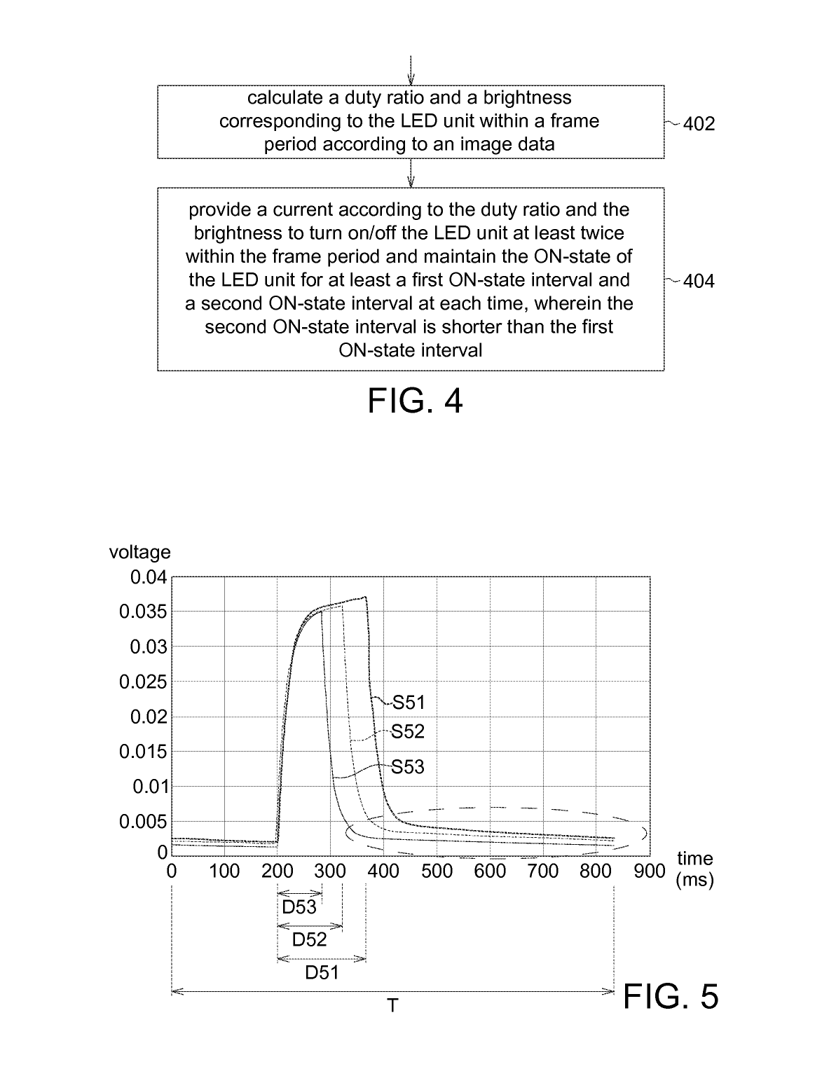

During the image display operation, the problem of red blurring caused by the red phosphor 106c of the LED unit 106 can be resolved through the control of the backlight driving module 101. Referring to FIG. 4, a flowchart of a backlight driving method according to an embodiment of the invention is shown. The driving method of the backlight driving module 101 includes following steps: Firstly, duty ratio, ON-OFF interval and brightness of the LED unit 106a within a frame period is calculated according to an image data VS (step 402). Then, a current is provided according to the calculated duty ratio, ON-OFF interval and brightness to turn on/off the LED unit 106 at least twice within the frame period and maintain the ON-state of the LED unit for at least a first ON-state interval and a second ON-state interval at each time, wherein the second ON-state interval is shorter than the first ON-state interval. In greater details, there is a first OFF-state interval existing between the first ON-state interval and the second ON-state interval, and the sum of the first ON-state interval and the second ON-state interval is substantially equivalent to the duty ratio (step 404). It should be noted that within the ON-state interval, the light emitting region of the display panel 104 corresponding to the LED unit 106 will receive a light source and accordingly display an image.

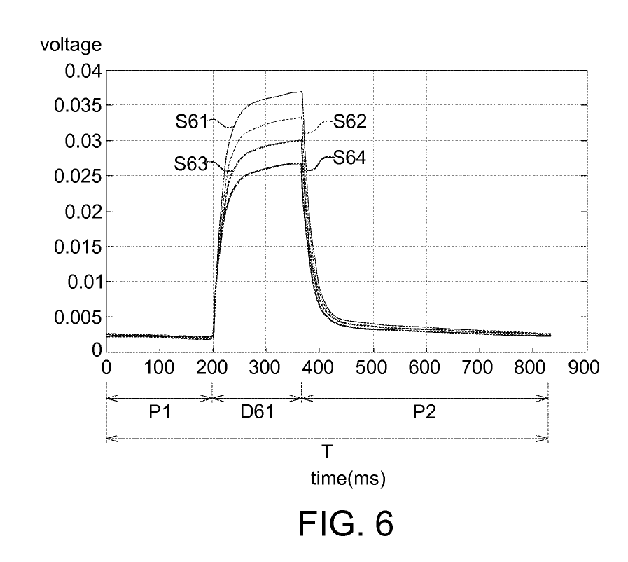

Referring to FIG. 5 and FIG. 6. FIG. 5 is a timing diagram of local dimming performed by the LED unit 106 driven by generally known technology. FIG. 6 is a timing diagram of local dimming performed by the LED unit 106 driven by the driving method of FIG. 4 according to an embodiment of the invention. In the embodiments illustrated in FIG. 5 and FIG. 6, after the backlight driving module 101 calculated the duty ratio and ON-OFF interval of the LED unit 106 according to the image data VS, the backlight driving module 101 turns on/off the LED unit 106.

As indicated in FIG. 5, the backlight driving module 101 uses a fixed current or voltage to turn on the LED unit 106 within a frame period T and maintain the ON-state of the LED unit 106 under duty ratios D51, D52 and D53. Thus, the total brightness provided by the LED unit 106 within a frame period T can be adjusted and the display panel 104 can be dimmed. Since the voltage applied to the LED unit 106 is proportional to the brightness of the LED unit 106, thus, for convenience purposes, as indicated in the driving timing diagram, the voltage as depicted FIG. 5 and the description thereof below will be directly exemplified by the brightness of the LED unit 106. Curves S51, S52 and S53 respectively represent a brightness vs time relationship obtained by the LED unit 106 when dimming is performed under duty ratios D51, D52 and D53.

As indicated in FIG. 6, the backlight driving module 101, under a fixed duty ratio D6, changes the brightness of the display panel 104 by modulating the intensity of the turn-on current of the LED unit 106. Curve S61, S62, S63 and S64 respectively represent the brightness vs time relationship obtained when dimming is performed under different intensities of turn-on current.

A comparison between FIG. 5 and FIG. 6 shows that when the display panel 104 is dimmed under different duty ratios D51, D52 and D53 according to the generally known technology, the degree of red blurring varies with the duty ratio, and it is difficult to compensate the red blurring phenomenon in subsequent process. As indicated in the circled portion of FIG. 5, the response time of the red phosphor 106c whose wavelength is between 600˜750 nm is millisecond (ms) level. Preferably, the response time of the red phosphor 106c is larger than 1 millisecond and smaller than 500 millisecond. As the duty ratio becomes larger, delay will occur when the backlight module is turned off, and the red blurring phenomenon will become worse. Unlike the dimming of FIG. 5 performed under different duty ratios, local dimming of FIG. 6 is performed by modulating the intensity of the turn-on current of the LED unit 106 under a fixed duty ratio. With the duty cycle being fixed, the brightness of the LED unit 106 can be adjusted and the blurring phenomena of curves S61, S62, S63 and S64 are almost substantially identical. Therefore, the display panel 104 can adjust local brightness, increase frame contrast and reduce power consumption without worsening the red blurring of the LED unit 106. Furthermore, backlight scanning technology can be used in subsequent embodiments to resolve the problem of red blurring.

Therefore, after the timing control unit 107 calculated the duty ratio, ON-OFF interval and brightness of the LED unit 106 according to the image data VS, the PWM unit 101c determines the pulse width of the outputted current, and the power conversion circuit 101b turns on/off the LED unit 106 more than twice within a frame period T. For example, when the LED unit 106 is turned on for the first time, the ON-state of the LED unit 106 is maintained for a longer primary ON-state interval; after the LED unit 106 has been turned off for a period of time, the LED unit 106 is briefly turned on again at least once, and these actions actuated in a frame period.

According to the generally known technology which the ON/OFF timing of the LED unit 106 is controlled by a switch only. In an embodiment of the invention, the backlight driving module 101 has at least two switch elements for controlling the ON/OFF state of the LED unit 106 to control the ON/OFF timing of the LED unit 106, such that the LED unit 106 can be turned on/off at least twice within a frame period T.

In some embodiments of the invention, the LED unit 106 is turned on less than or equal to five times within a frame period T. The sum of the primary and other ON-state intervals is equivalent to the duty ratio corresponding to the LED unit 106.

Referring to FIG. 8, a timing diagram of local dimming performed by the LED unit 106 driven by the driving method of FIG. 4 according to an alternate embodiment of the invention is shown. Within a frame period, the LED unit 106, having maintained the ON-state for a primary ON-state interval D1, is turned off and maintains the OFF-state for an OFF-state interval D2, and then is again turned on and maintains the ON-state for a shorter ON-state interval D3. Then, the LED unit 106 maintains the OFF-state for an OFF-state interval D4 and then is again briefly turned on/off three times. In each ON-state, the ON-state intervals D5, D7, and D9 are respectively followed by the OFF-state intervals D6, D8, and D10, and when the last OFF-state interval D10 finishes, a next frame period T+1 begins.

In some embodiments of the invention, the primary ON-state interval D1 is longer than other ON-state intervals D3, D5, D7, and D9. In some embodiments of the invention, the sum of the shorter ON-state intervals D3, D5, D7 and D9 is shorter than the primary ON-state interval D1. In some embodiments of the invention, the ratio of the primary ON-state interval D1 to the frame period T is substantially between 45%˜50%.

It should be noted that in some embodiments of the invention, the OFF-state interval D2 preferably is shorter than 1.67 milliseconds (ms). Except for the longer primary ON-state interval D1 and the longer OFF-state interval D2, the embodiments of the invention do not have specific restrictions regarding the lengths of the shorter ON-state intervals D3, D5, D7 and D9 and the shorter OFF-state interval D4, D6, D8 and D10. Therefore, anyone who is skilled in the technology field of the invention can make necessary adjustment according to the display requirements of the display panel 104. Preferably, the ON-state intervals are designed as: D3>D5>D7>D9, such that the red blurring phenomenon can be effectively eliminated. Also, a delay time (not illustrated) can be designed before the primary ON-state interval D1.

The timing control unit firstly calculates the duty ratio required within a frame period T. Then, through the pulse width modulation, the LED unit 106 is turned on briefly at least once (shorter ON-state intervals D3, D5, D7 and D9) after the primary ON-state interval D1 finishes, such that human eyes' perception of red blurring can be reduced. Thus, when resolving the problem of dynamic image sticking, the problem of red blurring generated when the response time of the red phosphor 106c of the LED unit 106 is too long is resolved at the same time. This is because within the shorter ON-state intervals D3, D5, D7 and D9, the red phosphor 106c, which requires a longer response time, does not have sufficient time to response. Meanwhile, the light generated by the LED unit 106 is greenish, hence compensating the problem of red blurring generated within the primary ON-state interval D1 and increasing the clarity of dynamic image and improving the display quality of the display panel 104.

According to above disclosure, a display apparatus and a backlight driving method of the same are provided in the embodiments of the invention. The display apparatus includes a backlight module, having at least one LED unit for driving the backlight driving module of the backlight module and a display panel receiving a light emitted from the backlight module. The backlight driving module of the backlight module modulates a current to turn on the LED unit within a frame period and maintain the ON-state of the LED unit for a primary ON-state interval, such that local dimming can be performed on the display apparatus to resolve the problem of red blurring due to fact that the response time of the red phosphor of the LED unit is too long. Following the primary ON-state interval, the LED unit is briefly turned on at least once, and the backlight scanning technology is used to further eliminate red blurring and dynamic image sticking to increase the clarity of dynamic images and improve the display quality.

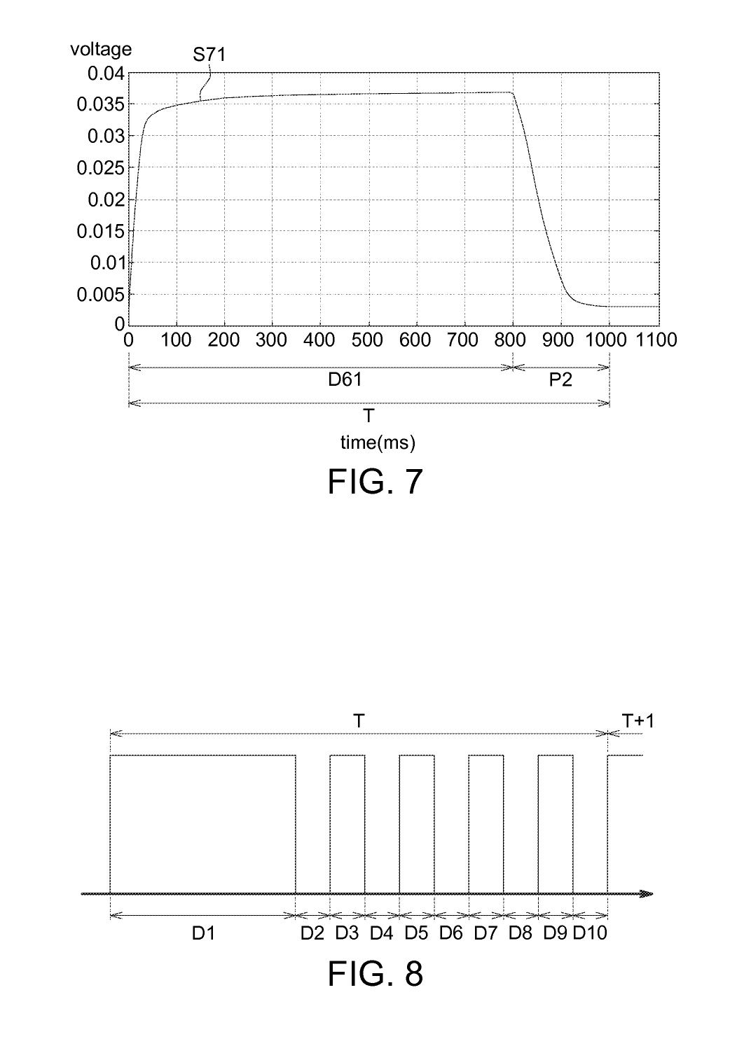

A human factor experiment is performed in the embodiment of FIG. 6 for examining relative relationship between human eyes' perception of red blurring and the length of duty ratio D61. The experiment shows that when the duty ratio D61 for the ON-state of the LED unit 106 is below 75%, human eyes have an obvious perception of red blurring. When the duty ratio D61 reaches 80%, human eyes have a delicate perception of red blurring (as indicated in curve S71 of FIG. 7). When the duty ratio D61 is over 85%, human eyes can hardly perceive red blurring. When the duty ratio D61 reaches 95%, the problem of red blurring no more exists.

Therefore, under the duty ratio D61, the backlight brightness of the LED unit 106 can be adjusted by modulating the intensity of the turn-on current of the LED unit 106, and the duty ratio D61 corresponding to the ON-state is prolonged such that the duty ratio D61 is substantially greater than 80% but smaller than 100% of the frame period T. Furthermore, without changing the predetermined sum of brightness within the frame period T, the problem of red blurring due to the long response time of the LED unit 10 can be resolved.

In the embodiments of FIG. 6 and FIG. 7, the second ON-state interval is 0, and the duty ratio D61 is constantly smaller than a frame period T. For example, the embodiment of FIG. 7 preferably has an OFF-state interval P2 substantially shorter than 1.67 milliseconds (ms) (1*0.2/120 HZ).

While the invention has been described by way of example and in terms of the preferred embodiment (s), it is to be understood that the invention is not limited thereto. On the contrary, it is intended to cover various modifications and similar arrangements and procedures, and the scope of appended claims therefore should be accorded the broadest interpretation so as to encompass all such modifications and similar arrangements and procedures.

What is claimed is:

1. A display apparatus, comprising:
a backlight module comprising at least one LED unit having at least a red phosphor;
wherein, the LED unit has a first ON-state interval and a second ON-state interval within a frame period, and the second ON-state interval is shorter than the first ON-state interval; and
a display panel disposed corresponding to the backlight module.

2. The display apparatus according to claim 1, wherein the LED unit is turned on less than or equal to five times within the frame period.

3. The display apparatus according to claim 2, further comprising a third ON-state interval, a fourth ON-state interval and a fifth ON-state interval, wherein the first ON-state interval is longer than the third ON-state interval, the fourth ON-state interval and the fifth ON-state interval.

4. The display apparatus according to claim 3, wherein the sum of the second ON-state interval, the third ON-state interval, the fourth ON-state interval and the fifth ON-state interval is shorter than the first ON-state interval.

5. The display apparatus according to claim 2, wherein a ratio of the first ON-state interval to the frame period is between 45˜50%.

6. The display apparatus according to claim 1, wherein the LED unit comprises a blue LED chip covered by the red phosphor, and the response time of the red phosphor is in millisecond (ms) level.

7. The display apparatus according to claim 6, wherein the response time of the red phosphor is larger than 1 millisecond and smaller than 500 millisecond.

8. The display apparatus according to claim 1, wherein the second ON-state interval is 0, and the first ON-state interval is greater than 80% but smaller than 100% of the frame period.

9. The display apparatus according to claim 8, wherein the LED unit is turned off at least once within the frame period, and an OFF-state interval is maintained for less than 1.25 milliseconds (ms).

10. The display apparatus according to claim 1, further comprising:
a timing control unit used for calculating a duty ratio corresponding to the LED unit according to an image data;
a backlight driving module used for driving the backlight module, wherein the backlight driving module comprises a pulse width modulation (PWM) and determines a pulse width of an outputted current according to the duty ratio; and
a power conversion circuit used for providing a current to turn on/off the LED unit according to the pulse width.

11. The display apparatus according to claim 1, wherein the display panel is disposed above the backlight module.

12. The display apparatus according to claim 1, wherein the LED unit further has at least a green phosphor.

13. A backlight driving method of a display apparatus used for driving a backlight module having at least a LED unit, wherein the method comprises:
calculating a duty ratio and a brightness of the LED unit within a frame period according to an image data; and
providing a current according to the duty ratio and the brightness to turn on the LED unit at least twice within the frame period and maintain the ON-state of the LED unit for at least a first ON-state interval and a second ON-state interval, wherein an OFF-state interval is between the first ON-state interval and the second ON-state interval, and the second ON-state interval is shorter than the first ON-state interval.
